(19) United States
(12) Patent Application Publication
(10) Pub. No.: US 2012/0082901 A1
(43) Pub. Date: Apr. 5, 2012

(54) LITHIUM-BASED ANODE WITH IONIC LIQUID POLYMER GEL

(75) Inventors: Rudiger Schmidt, Paderborn (DE); Daher Michael Badine, Mannheim (DE); Helmut Moehwald, Annweiler (DE); Igor Kovalev, Vail, AZ (US); Yuriy V. Mikhaylik, Tucson, AZ (US)

(73) Assignees: BASF SE, Ludwigshafen (DE); Sion Power Corporation, Tucson, AZ (US)

(21) Appl. No.: 13/249,632

(22) Filed: Sep. 30, 2011

Related U.S. Application Data
(60) Provisional application No. 61/388,117, filed on Sep. 30, 2010.

(51) Int. Cl. H01M 10/056; H01M 4/38; H01M 4/04; H01M 4/48; H01M 4/485; H01M 4/58; H01M 4/62; H01M 4/40

(52) U.S. Cl. 429/308; 429/215; 429/188; 429/317; 429/314; 429/309; 429/199; 429/205; 429/339; 429/341; 429/337; 429/340; 429/336; 429/324; 429/327; 429/328; 429/329; 429/315; 429/313; 427/58

(57) ABSTRACT

Li-based anodes for use in an electric current producing cells having long life time and high capacity are provided. In certain embodiments, the Li-based anode comprises at least one anode active Li-containing compound and a composition comprising at least one polymer, at least one ionic liquid, and optionally at least one lithium salt. The composition may be located between the at least one Li-containing compound and the catholyte used in the electric current producing cell. In some embodiments, the at least one polymer may be incompatible with the catholyte. This configuration of components may lead to separation between the lithium active material of the anode and the catholyte. Processes for preparing the Li-based anode and to electric current producing cells comprising such an anode are also provided.

### RELATED APPLICATIONS

The present application claims priority under 35 U.S.C. §119(e) to U.S. provisional patent application Ser. No. 61/388,117, filed Sep. 30, 2010, which is incorporated herein by reference in its entirety.

### FIELD OF INVENTION

The present application relates generally to electrochemical cells, and more specifically, to electrochemical cells, components and methods involving lithium-based anodes and ionic liquids.

### BACKGROUND

There has been considerable interest in recent years in developing high energy density batteries with lithium containing anodes. Lithium metal is particularly attractive as the anode of electrochemical cells because of its extremely light weight and high energy density compared to other anodes, such as lithium intercalated carbon anodes, where the presence of non-electroactive materials increases weight and volume of the anode, and thereby reduces the energy density of the cells. Moreover, lithium metal anodes, or those comprising mainly lithium metal, provide an opportunity to construct cells which are lighter in weight, and which have a higher energy density than cells such as lithium-ion, nickel metal hydride or nickel-cadmium cells. These features are highly desirable for batteries for portable electronic devices such as cellular phones and laptop computers where a premium is paid for low weight. Unfortunately, the reactivity of lithium and the associated cycle life, dendrite formation, electrolyte compatibility, and fabrication and safety problems have hindered the commercialization of lithium cells. Despite the various approaches proposed for forming lithium anodes and forming interfacial and/or protective layers, improvements are needed.

### SUMMARY OF THE INVENTION

The present application relates generally to electrochemical cells, and more specifically, to electrochemical cells, components and methods involving lithium-based anodes with ionic liquids and optionally, polymer gels. The subject matter of the present invention involves, in some cases, interrelated products, alternative solutions to a particular problem, and/or a plurality of different uses of one or more systems and/or articles.

In some embodiments, Li-based anodes for use in an electric current producing cell are provided. In one set of embodiments, the Li-based anode comprises at least one anode active Li-containing compound and a composition located between the at least one Li-containing compound and a catholyte used in the electric current producing cell. The composition comprises at least one ionic liquid and at least one polymer compatible with the at least one ionic liquid. In certain embodiments, the composition further comprises at least one lithium salt.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic diagram showing an electrochemical cell according to one set of embodiments.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### DETAILED DESCRIPTION

Li-based anodes for use in an electric current producing cells having long life time and high capacity are provided. In certain embodiments, the Li-based anode comprises at least one anode active Li-containing compound and a composition comprising at least one polymer, at least one ionic liquid, and optionally at least one lithium salt. The composition may be located between the at least one Li-containing compound and the catholyte used in the electric current producing cell. In some embodiments, the at least one polymer may be incompatible with the catholyte. This configuration of components may lead to separation between the lithium active material of the anode and the catholyte. Processes for preparing the Li-based anode and to electric current producing cells comprising such an anode are also provided.

There is a high demand for long lasting rechargeable electric current producing cells having high energy density. Such electric current producing cells are used for portable devices as notebooks or digital cameras and will play a major role in the future for the storage of electric energy produced by renewable sources. Lithium has one of the highest negative standard potential of all chemical elements. Electric current producing cells with a Li-based anode therefore have very high cell voltages and very high theoretical capacities. For these reasons Li is very suited for use in electric current producing cells. One problem occurring with the use of Li in electric current producing cells is the high reactivity of Li, e.g. towards water and certain solvents. Due to its high reactivity the contact of Li with commonly used liquids electrolytes may lead to reactions between Li and the electrolyte whereby Li is consumed irreversibly. Hence, the long time stability of the electric current producing cell is affected adversely.

Depending on the material used for the cathode of the electric current producing cell further unwanted reactions of the Li may occur. For instance, one problem of Li/S-batteries is the good solubility of the polysulfides formed at the cathode in the electrolyte. The polysulfides may diffuse from the cathodic region into the anodic region. There, the polysulfides are reduced to solid precipitates (Li₂S₂ and/or Li₂S), resulting in a loss of active material at the cathode and therefore decreasing the capacity of the Li/S-battery. The rate of sulphur usage is normally about 60% of the deployed sulphur in the cathode.

The above-mentioned lithium sulphur (Li/S) battery is a rechargeable battery with promising characteristics. In Li/S-batteries, the anode active material may be Li-metal and the cathode active material may be sulphur. In the discharge modus Li⁰ dissociates into an electron and a Li⁺-ion which is dissolved in the electrolyte. This process is called lithium stripping. At the cathode the sulphur is initially reduced to polysulfides like Li₂S₈, Li₂S₆, Li₂S₄, and Li₂S₃. These polysulfides are soluble in the electrolyte. Upon further reduction Li₂S₂ and Li₂S are formed which precipitate.

In the charge modus of the Li/S-battery the Li⁺-ion is reduced to Li⁰ at the anode. The Li⁺-ion is removed from the electrolyte and precipitated on the anode, thereby. This is called lithium plating. Li₂S₂ and Li₂S are oxidized to polysulfides (like Li₂S₄, Li₂S₆, and Li₂S₈) and sulphur (S₈) at the cathode.

Li/S-batteries have a four times higher theoretical specific energy than Li-ion batteries, especially their gravimetric energy density (Wh/kg) is higher than that of Li-ion batteries. This is an important feature for their possible use as rechargeable energy source for automobiles. In addition, the sulphur used as main material in the cathode of the Li/S-batteries is much cheaper than the Li-ion intercalation compounds used in Li-ion batteries.

Despite the fact that there has been long and intense research in the field of Li-batteries like Li/S-batteries, there is still the need for further improvements of this kind of batteries to obtain Li-batteries which are capable of being charged/discharged a high number of cycles without losing too much of their capacity.

These issues may be addressed by articles described herein, such Li-based anodes for use in an electric current producing cell, and electric current producing cells including such anodes.

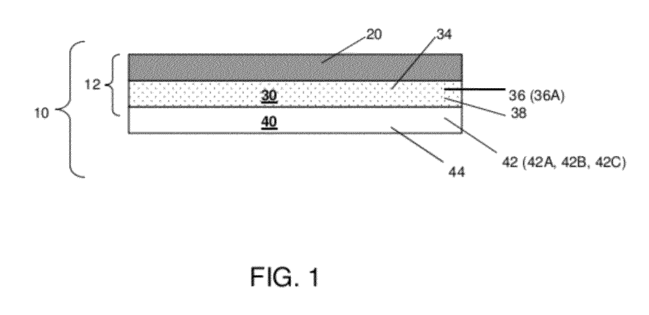

FIG. 1 shows an example of an electric current producing cell 10 including a lithium-based anode 12 described herein. In some embodiments, lithium-based anode 12 includes a layer including at least one anode active lithium-containing compound 20 and a layer including a composition 30 located between the at least one lithium-containing compound and a cathode 40 used in the electric current producing cell. Composition 30 may further include an ionic liquid 34 and at least one polymer 36 (e.g., an uncross-linked polymer or a cross-linked polymer 36A), which may be compatible with the at least one ionic liquid 34. In some embodiments, the composition may further include at least one lithium salt 38. The cathode may include a catholyte 42, which may optionally comprise one or more of: a solvent or mixture of solvents 42A, one or more electrolyte salts 42B, and one or more polymers 42C. In addition to catholyte 42, cathode 40 may further include a cathode active compound 44. Although not shown in FIG. 1, in some embodiments a separator is positioned between anode 12 and cathode 40.

In some embodiments, a Li-based anode comprises:
at least one anode active Li-containing compound 20 and
a composition 30 located between the at least one Li-containing compound and
a catholyte 42 used in the electric current producing cell, containing at least one ionic liquid 34,
at least one polymer 36 compatible with the at least one ionic liquid 34, and optionally at least one lithium salt 38.

It should be appreciated that while much of the description provided herein involves components for use in lithium metal electrochemical cells, other alkali metal electrochemical cells as well as lithium-ion electrochemical cells may benefit from aspects of the invention. Furthermore, it should be understood that not all components shown in FIG. 1 need be present in the articles described herein. Furthermore, articles such as electrochemical cells and precursors to electrochemical cells may include additional components that are not shown in FIG. 1. Moreover, articles may include other configurations and arrangements of components besides those shown in FIG. 1.

In one set of embodiments, catholyte 42 used in the electric current producing cell comprises a solvent or mixture of solvents 42A and the at least one polymer 36 is immiscible with said solvent or mixture of solvents 42A.

In some embodiments, the Li-based anode described herein comprises a composition located between the anode active Li containing compound and the catholyte used in the electric current producing cells. This composition may comprise at least one ionic liquid and at least one polymer which is compatible with the at least one ionic liquid. In some cases, the polymer is immiscible with the solvent used in the catholyte.

The composition may have a positive influence on the cycle stability of the cell. In some embodiments, it may keep the catholyte solvent(s) away from the anode active Li containing compound but does not affect adversely the ion conductivity of the anode due to its ionic structure. In one set of embodiments, if the solvent(s) 42A used in the catholyte are not miscible with the polymer(s) 36, the solvent(s) 42A are not able to penetrate the composition and do not, or barely, come into contact with the anode active Li-containing compound (e.g., during cycling of the cell). Accordingly, adverse reactions of the catholyte or the solvents contained therein or the polysulfides from the cathodic region with the anode active compound may be reduced.

In some embodiments, if the catholyte is in direct contact with the composition 30, the at least one polymer 34 may precipitate at the interface and form a solid layer which may act as separator, and may further enhance the separation of the catholyte 42 and the anode active compound 20.

The ionic liquid may allow the exchange of Li-ions and may optionally include one or more lithium salts. In some embodiments, the use of ionic liquids comprising NO₃⁻ as anion may be beneficial, since this N—O compound has a positive influence on the stability of the Li-based anode. The NO₃⁻ further may form a film on the surface of the Li-containing compound 20, which may further protect the anode active Li-containing compound 20 against the catholyte solvent 42A. Due to the separation of the catholyte 42 and the anode active Li-containing compound 20 by composition 30, the selection of the catholyte solvent 42A may be less restricted. Specifically, in some cases highly polar solvents may be used. The present application also provides means for improving the performance of Li-based electric current producing cells wherein commonly used non-aqueous electrolyte solvents can be used.

Various configurations and variations of the articles and methods described herein are described in more detail below.

The term “electric current producing cell” as used herein is intended to include batteries, primary and secondary electrochemical cells and especially rechargeable batteries.

The term “anode active Li-containing compound” as used herein is intended to denote Li-containing compounds which release Li⁺-ions during discharge of the electric current producing cell, i.e. the Li contained in the anode active compound(s) is oxidized at the anode. During charge of the electric current producing cell (if the cell is a rechargeable cell) Li⁺-ions are reduced at the anode and Li is incorporated into the anode active Li-containing compound.

Anode active Li-containing compounds are known. The anode active Li-compound may be selected from the group consisting of lithium metal, lithium alloy and lithium intercalating compounds. All these materials are capable of reversibly intercalating lithium ions as Li⁰ or reversibly reacting with lithium ions to form a lithium (Li⁰) containing compound. For example, different carbon materials and graphite are capable of reversibly intercalating and de-intercalating lithium ions. These materials include crystalline carbon, amorphous carbon, or mixtures thereof. Examples for lithium alloys are lithium tin alloy, lithium aluminium alloy, lithium magnesium alloy and lithium silicium alloy. Lithium metal may be in the form of a lithium metal foil or a thin lithium film that has been deposited on a substrate. Lithium intercalating compounds include lithium intercalating carbons and lithium intercalating graphite. Lithium and/or Li-metal alloys can be contained as one film or as several films, optionally separated by a ceramic material (H). Suited ceramic materials (H) are described below.

“Ionic liquids” are also referred to as liquid or molten salts or salt melts. The ionic liquids described herein generally refer to compounds that are in liquid form during normal operation conditions of an electrochemical cell or a component of an electrochemical cell comprising the ionic liquid, as understood by one of ordinary skill in the art (e.g., during fabrication, storage, and/or cycling of the electrochemical cell or component of the electrochemical cell). For example, although sodium chloride (NaCl) may be an ionic liquid at temperatures above 801° C. (e.g., the melting point of NaCl), such temperatures would not be suitable for operating an electrochemical cell described herein, and thus, NaCl would not constitute an ionic liquid for the purposes described herein.

In some embodiments, the ionic liquids described herein may have a melting point of less than 180° C. In some cases, the melting point of the ionic liquid is in the range from −50° C. to 150° C., in the range from −20° C. to 120° C., or in the range from 0° C. to 100° C. In some embodiments, the ionic liquids described herein may have a melting point less than the melting point of the anode active material (e.g., lithium metal). In further embodiments, the ionic liquids used may have a melting point below 25° C., i.e. less than room temperature, below 0° C., or below −20° C. The ionic liquids described herein are generally conductive liquids, having high ion conductivity, a wide electrochemical stability window, and are non-volatile, thermally stable and non-flammable.

“Catholyte” denotes the electrolyte in the cathodic region of an electric current producing cell.

“Anolyte” means the electrolyte in the anodic region of an electric current producing cell.

In some embodiments, the Li-based anode described herein for use in an electric current producing cell comprises a composition 30 containing at least one ionic liquid 34 and at least one polymer 36. Composition 30 may include, for example, one, two, three or more ionic liquids or mixtures of two or more ionic liquids and one, two, three or more polymers. Composition 30 may act as an anolyte in the electric current producing cell. A majority of the anolyte may be located between the at least one anode active Li-containing compound 20 and the catholyte 42 used in the electric current producing cell (e.g., prior to cycling of the cell and/or during cycling of the cell). The composition may separate the catholyte and the anode active Li-containing compound 20 physically, and it may prevent or reduce the occurrence of unwanted reactions between the catholyte 42 and the anode active Li-containing compound 20.

In certain embodiments in which composition 30 comprises at least one ionic liquid which is able to conduct Li⁺-ions, the charge/discharge of the electric current producing cell is not hindered. The at least one polymer 36 may be used to thicken the ionic liquid(s) 34 and to improve the adhesion/wetting of the ionic liquid(s) 34 on the Li-containing compound or a protective layer optionally positioned between the anode-active Li-containing compound and the composition. The combination of ionic liquid 34 and polymer 36 compatible with 34 may yields an efficient anolyte formed by a polymer gel.

As described herein, composition 30 may include a liquid portion and a polymer portion. In certain embodiments, at least 10 wt.-%, at least 20 wt.-%, at least 30 wt.-%, at least 40 wt.-%, at least 50 wt.-%, at least 60 wt.-%, at least 70 wt.-%, at least 80 wt.-%, at least 90 wt.-%, at least 95 wt.-%, at least 99 wt.-%, and up to 100 wt.-% of the liquid portion of composition 30 is an ionic liquid. Other solvents, such as those described herein, may be used in combination with one or more ionic liquids to form the liquid portion of composition 30.

A polymer and a solvent are compatible when the polymer can be solvated in or is swellable in the solvent. With respect to the compatibility between polymer(s) 36 and an ionic liquid 34, for example, compatibility means that the polymer(s) 36 can be solvated in or are swellable in (e.g. in the case that the polymer(s) 36 are crosslinked) the at least one ionic liquid 34. In some embodiments (e.g., in which the polymer is not crosslinked), the polymer(s) 36 and the ionic liquid(s) 34 are compatible if, after an excess amount of the polymer(s) 36 is immersed the ionic liquid(s) 34 at 25° C. for 24 hours, the solvated mixture contains at least 2 wt.-%, at least 5 wt.-%, or at least 10 wt.-% solvated polymer, based on the total weight of the mixture (which includes the solvated polymer and the ionic liquid(s), but does not include the non-solvated polymer). In some embodiments (e.g., in which the polymer is crosslinked), the polymer(s) and the ionic liquid(s) are compatible if, after the polymer is immersed in an excess amount of the ionic liquid(s) 34 at 25° C. for 24 hours, the swollen polymer contains at least 2 wt.-%, at least 5 wt.-%, or at least 10 wt.-% of the at least one ionic liquid 34, based on the weight of the polymer prior to the immersion step (the swollen polymer includes the weight of the polymer and the weight of the ionic liquid(s) taken up by the polymer, but does not include the weight of the ionic liquid(s) that are not taken up by the polymer).

In some embodiments, composition 30 may be applied as a thin film on the anode active Li-containing compound. In some cases, composition 30 is applied to all parts of the at least one anode active Li-containing compound which would otherwise come into contact with the catholyte and/or the solvent(s) contained therein to prevent the contact between catholyte and anode active Li-containing compound. In other embodiments, the composition 30 is applied as a thin film on a protective layer formed on the anode active Li-containing compound, as described in more detail below.

In some embodiments, the at least one polymer 36 is selected so as to be immiscible with the solvent or mixture of solvents 42A contained in the catholyte (42) used in the electric current producing cell. For instance, in some cases the polymer(s) 36 is not substantially soluble or swellable in the catholyte solvent(s) 42A used. This may inhibit or at least prevent the direct contact of the catholyte and the anode active Li-containing compound 20. “Immiscible” according to the invention means that, after a major component has been mixed with an excess of a minor component at 25° C. for 24 hours, the amount of the minor component in the mixture is at most 10 wt.-%, at most 5 wt.-%, or at most 2 wt.-% in the mixture, based on the total weight of the major and the minor component. For example, a non-crosslinked polymer 36 and a solvent/mixture of solvents 42A are immiscible when the amount of polymer 36 solvated by the solvent/mixture of solvents 42A yields a mixture with concentrations of the solvated polymer 36 of at most 10 wt.-%, at most 5 wt.-% or at most 2 wt.-% in the mixture, based on the total weight of solvated polymer 36 and solvent/mixture of solvents 42A, measured by immersing an excess amount of the at least one polymer 36 in the respective solvent/mixture of solvents 42A at 25° C. for 24 hours. As another example, a cross-linked polymer 36 and a solvent/mixture of solvents 42A are immiscible when a solvent/mixture of solvents 42A is added to a polymer 36 and results in a non-swollen polymer or a polymer swollen only to the degree that the amount of the solvent/mixture of solvents 42A within the swollen polymer is at most 10 wt.-%, at most 5 wt.-%, or at most 2 wt.-%, based on the total weight of polymer 36 and solvent/mixture of solvents 42A within the swollen polymer, measured by immersing the polymer 36 in an excess amount of the solvent/mixture of solvents 42A in at 25° C. for 24 hours.

In one set of embodiments, a polymer and a solvent are immiscible when at least one polymer 36 is immersed in an excess amount of the respective solvent or mixture of solvents 42A at 25° C. for 24 hours, and yields solutions with concentrations of polymer 36 solvated by the solvent/mixture of solvents 42A of at most 10 wt.-%, at most 5 wt.-%, or at most 2 wt.-% of the at least one polymer 36, based on the total amount of solvated polymer 36 and solvent/mixture of solvents 42A. Solution denotes the solvent/mixture of solvents 42A containing the solved polymer 36, not the fraction of the polymer not solvated, usually the supernatant obtained by the immersion procedure.

In certain embodiments, the at least one polymer 36 is selected from the group consisting of cellulose, cellulose derivatives like cellulose ethers, e.g. methyl cellulose and cellulose esters, e.g. carboxymethyl cellulose, polyacrylates, polyethers like polyethylenoxide and polyethyleneglycole mono- and dimethylether, polyethersulfones, copolymers containing polyethersulfones, and mixtures thereof, although other polymers can be used.

The weight averaged molecular weight of polymer 36 may vary. In some embodiments, polymer 36 has a weight averaged molecular weight of from 25,000 to 40,000 g/mol, from 30 000 to 35 000 g/mol, from 10 000 to 200 000 g/mol, from 15 000 to 150 000 g/mol, from 20 000 to 100 000 g/mol, from 40 000 to 1 500 000 g/mol, from 40 000 to 1 000 000 g/mol, from 60 000 to 800 000 g/mol determined by means of GPC. In some cases, the weight averaged molecular weight of the polymer is less than 1 500 000 g/mol, less than 1 000 000 g/mol, less than 750 000 g/mol, less than 500 000 g/mol, less than 250 000 g/mol, less than 100 000 g/mol, less than 75 000 g/mol, less than 50 000 g/mol, less than 25 000 g/mol, or less than 10 000 g/mol. In certain embodiments, the weight averaged molecular weight of the polymer is greater than 10 000 g/mol, greater than 25 000 g/mol, or greater than 50 000 g/mol. Combinations of the above-noted ranges are also possible.

Cellulose is a linear organic polymer composed of about several hundred to ten thousand linked beta-D-1,4 glucose units and is the main component of the primary cell wall of green plants. Common sources of cellulose are may be used as the at least one polymer 36 and may have an averaged degree of polymerization of, for example, from 120 to 500. The cellulose may have an weight averaged molecular weight of from 10 000 to 200 000 g/mol, from 15 000 to 150 000 g/mol, or from 20 000 to 100 000 g/mol. Degree of polymerization and the weight averaged molecular weight may both be determined by means of GPC. In some cases, the cristallinity may be from 50 to 90% (e.g., from 60 to 90%, from 60 to 80%, from 50 to 80%, or from 70 to 90%). The molecular weight of the cellulose may be determined by esterification of the cellulose with a mixture of acetic acid/acetic acid anhydride in the presence of sulphuric acid yielding cellulose acetate soluble in acetone. The solution of the obtained cellulose acetate in acetone can then be used for the determination of the molecular weight, e.g. by GPC.

In a some embodiments, cellulose is used as the at least one polymer 36 having a weight averaged molecular weight of from 40 000 to 1 500 000 g/mol, e.g., from 40 000 to 1 000 000 g/mol or from 60 000 to 800 000 g/mol, although other molecular ranges may be possible.

Polyethersulfones are polymeric materials containing SO₂ groups (sulfonyl groups) and oxygen atoms that form part of ether groups in their constitutional repeating units. Polyethersulfones can be aliphatic, cycloaliphatic, aromatic polyethersulfones or may contain aliphatic, cycloaliphatic and/or aromatic polyethersulfones-units.

In one set of embodiments, the at least one polymer 36 is selected from polyethersulfones that can be described by the following formula:

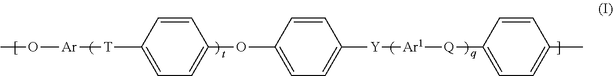

The integers can have the following meanings:
t, q independently 0, 1, 2 or 3,
Q, T, Y: each independently a chemical bond or group selected from —O—, —S—, —SO₂—, S═O, C═O, —N═N—, —R^{I}C═CR^{II}, —CR^{III}R^{IV}—, where R^{I} and R^{II} are each independently a hydrogen atom or a C₁-C₁₂-alkyl group and R^{III} and R^{IV} are different or identical and independently a hydrogen atom or a C₁-C₁₂-alkyl, C₁-C₁₂-alkoxy or C₆-C₁₈-aryl group, where R^{III} and R^{IV} alkyl, alkoxy or aryl can be substituted independently by fluorine and/or chlorine or where R^{III} and R^{IV}, combine with the carbon atom linking them to form C₃-C₁₂-cycloalkyl optionally substituted by one or more C₁-C₆-alkyl groups, at least one of Q, T and Y being other than —O— and at least one of Q, T and Y being —SO₂—, and
Ar, Ar¹: independently C₆-C₁₈-arylene optionally substituted by C₁-C₁₂-alkyl, C₆-C₁₈-aryl, C₁-C₁₂-alkoxy or halogen.

Q, T and Y can therefore each independently be a chemical bond or one of the abovementioned atoms or groups, in which case “a chemical bond” is to be understood as meaning that, in this case, the left-adjacent and right-adjacent groups are directly linked to each other via a chemical bond. In one set of embodiments, at least one element of Q, T and Y is other than —O— and at least one element from Q, T and Y is —SO₂—. In certain embodiments, Q, T and Y are each independently —O— or —SO₂—.

C₁-C₁₂-alkyl groups may comprise linear or branched, saturated alkyl groups having from 1 to 12 carbon atoms. The following radicals may be mentioned in particular: C₁-C₆-alkyl, such as methyl, ethyl, n-propyl, iso-propyl, n-butyl, sec-butyl, 2- or 3-methylpentyl and longer-chain radicals such as non-branched heptyl, octyl, nonyl, decyl, undecyl, lauryl and the singly or multiply branched analogues thereof.

When Ar and/or Ar¹ is/are substituted with C₁-C₁₂-alkoxy, the above-defined alkyl groups having from 1 to 12 carbon atoms may be useful as alkyl in the alkoxy groups. Suitable cycloalkyl groups may comprise C₃-C₁₂-cycloalkyl groups, for example cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, cyclopentylpropyl, cyclopentylbutyl, cyclopentylpentyl, cyclopentylhexyl, cyclohexylmethyl, cyclohexyldimethyl, cyclohexyltrimethyl.

Useful C₆-C₁₈-arylene groups Ar and Ar¹ may include phenylene groups, such as 1,2-, 1,3- and 1,4-phenylene, naphthylene groups, especially 1,6-, 1,7-, 2,6- and 2,7-naphthylene, and also the bridging groups derived from anthracene, phenanthrene and naphthacene. In some embodiments, Ar¹ is unsubstituted C₆-C₁₂-arylene, e.g., phenylene, such as 1,2-, 1,3- or 1,4-phenylene, or naphthylene.

Hydroxyl groups in polyethersulfone can be free hydroxyl groups, the respective alkali metal salts or alkyl ethers, such as the respective methyl ethers.

In some cases, the polyethersulfone is a linear polyethersulfone.

In one particular embodiment, the at least one polymer 36 can be selected from branched polyethersulfones.

In some embodiments, the anode described herein comprises at least one polyethersulfone. In one embodiment, the anode may comprise a mixture or blend of at least two of the polyethersulfones, e.g., such as those described herein, or a blend of polyethersulfone with an additional (co)polymer 36A.

In one embodiment, the polymer 36 may be applied as a blend from polyethersulfone and an additional (co)polymer 36A. Suitable (co)polymers 36A may be any (co)polymers that are compatible with the respective polyethersulfone and/or compatible with the solvent used with the polymer 36.

In one set of embodiments, the at least one polymer 36 is selected from the group consisting of polyarylethersulfones, e.g., made from 4,4′-dihydroxydiphenyl sulfone and 4,4′-dichlorodiphenyl sulfone or polycondensation products of 4-phenoxyphenylsulfonylchloride; polysulfones, e.g., alkylated, such as methylated polycondensation products of the disodium salt of bisphenol A and 4,4′-dichlorodiphenyl sulfone; polyphenylsulfones, e.g., the reaction products of 4,4′-biphenol and 4,4′-dichlorodiphenyl sulfone; copolymers containing polyarylethersulfones, polysulfones and/or polyphenylsulfones, and mixtures thereof.

In one embodiment, the polyethersulfone used has a weight averaged molecular weight M_{w} of from 25,000 to 40,000 g/mol, of from 28,500 to 35,000 g/mol, or of from 32,000 to 34,000 g/mol, determined by gelpermeation chromatography (GPC). Suitable solvents for determining the molecular weight of polyethersulfone may include 1,3-dioxolane, 1,4-dioxolane and diglyme.

In some cases, the at least one polymer 36 is cross-linked; however, in other embodiments, at least one polymer 36 in the composition is not cross-linked.

In one set of embodiments, the at least one ionic liquid 34 may be selected from salts of the general formula

[A]⁺ₙ[Y]ⁿ⁻
with n=1, 2, 3 or 4;
[A]⁺ is selected from the group consisting of ammonium cation, oxonoium cation, sulfonium cation and phosphonium cation; and
[Y]ⁿ⁻ is a monovalent, bivalent, trivalent or tetravalent anion;
   and of salts of the general formulae (IIa) to (IIc)

[A¹]⁺[A²]⁺[Y]ⁿ⁻(IIa) with n=2,

[A¹]⁺[A²]⁺[A³]⁺[Y]ⁿ⁻(IIb) with n=3, and

[A¹]⁺[A²]⁺[A³]⁺[A⁴]⁺[Y]ⁿ⁻(IIc) with n=4,
wherein
[A¹]⁺, [A²]⁺, [A³]⁺ and [A⁴]⁺ independently from each other are selected from the group as defined for [A]⁺; and
[Y]ⁿ⁻ is defined as above.

In some embodiments, [A]⁺ may be a carbocyclic or heterocyclic compound (e.g., a 4-, 5-, 6-, or 7-membered monocyclic ring system, optionally including one, two, or three heteroatoms such as oxygen, nitrogen, sulphur, or phosphorus). In other embodiments, [A]⁺ may be a non-cyclic compound.

In some embodiments, [A]⁺ may be selected from compounds of general formulae (IIIa) to (IIIy):

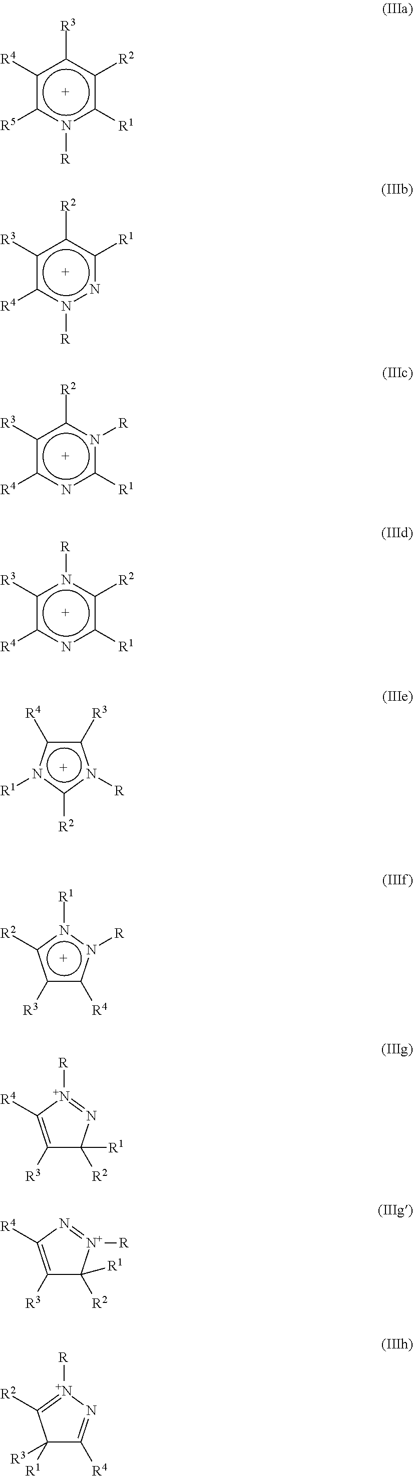

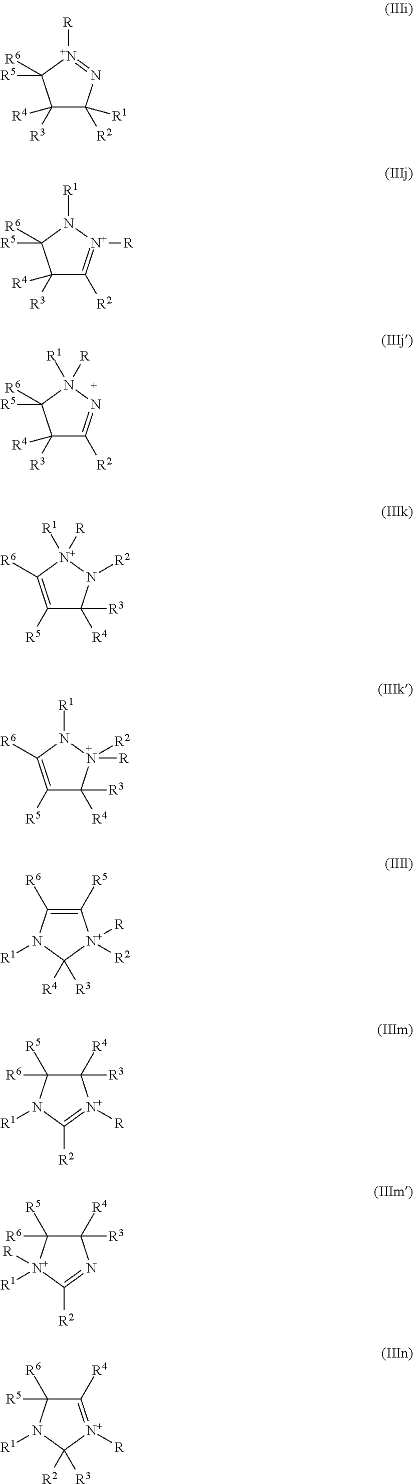

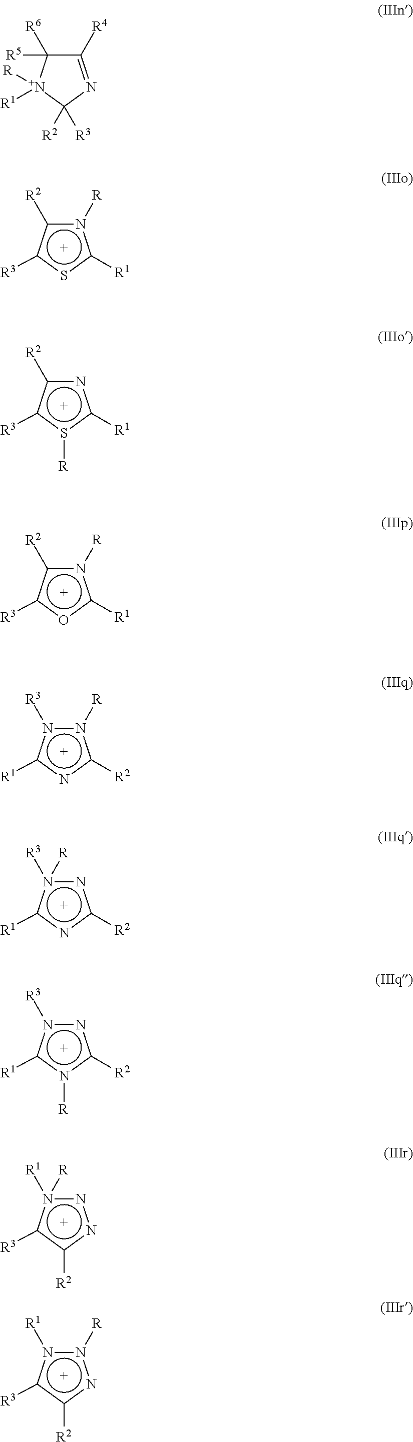

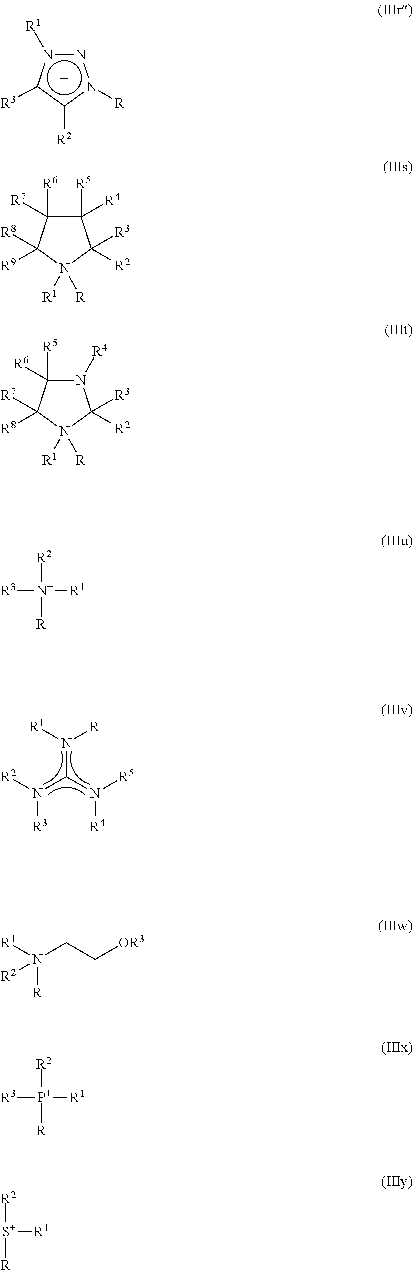

and oligomers comprising these structures; wherein
R is selected from hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
R¹ to R⁹ are independently from each other are selected from hydrogen; a sulfo-group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, wherein R¹ to R⁹ which are bound to a carbon atom in the aforesaid formulae (IIIa) to (IIIy) may be selected from halogen or a functional group; and/or
two adjacent radicals from the group R¹ to R⁹ may be together a bivalent carbon containing organic saturated or unsaturated, acyclic or cyclic, aliphatic, aromatic or araliphatic radical which has from 1 to 30 carbon atoms and may be unsubstituted or interrupted or substituted by 1 to 5 hetero atoms or functional groups; and/or
two adjacent radicals from the group consisting of R and R¹ to R⁹ may together form a 3 to 7-membered saturated, unsaturated or aromatic ring and may be un-substituted or be interrupted or substituted by from 1 to 5 heteroatoms or functional groups.

In the definitions of the radicals R and R¹ to R⁹, possible heteroatoms are in principle all heteroatoms which are able to formally replace a —CH₂— group, a —CH═ group, a —C≡ group or a ═C═ group. If the carbon-comprising radical comprises heteroatoms, then oxygen, nitrogen, sulfur, phosphorus and silicon may be included. Examples of suitable groups may include —O—, —S—, —SO—, —SO₂—, —NR′—, —N═, —PR′—, —PR′₂ and —SiR′₂—, where the radicals R′ are the remaining part of the carbon-comprising radical.

Suitable functional groups are in principle all functional groups which can be bound to a carbon atom or a heteroatom. Suitable examples are —OH (hydroxyl), ═O (in particular as carbonyl group), —NH₂ (amino), ═NH (imino), —COOH (carboxyl), —CONH₂ (carboxamide), —SO₃H (sulfo) and —CN (cyano). Functional groups and heteroatoms can also be directly adjacent, so that combinations of a plurality of adjacent atoms, for instance —O— (ether), —S— (thioether), —COO— (ester), —CONN— (secondary amide) or —CONR′— (tertiary amide), are also comprised, for example di-(C₁-C₄-alkyl)amino, C₁-C₄-alkyloxycarbonyl or C₁-C₄-alkyloxy.

In some cases, the ionic liquid includes a halogen or a halide. A halogen may include, for example, fluorine, chlorine, bromine and iodine. Halides include, for example, fluoride, chloride, bromide and iodide.

Radicals R and R¹ to R⁹ may be included, each being, independently of one another,
hydrogen;
unbranched or branched C₁-C₁₈-alkyl which may be unsubstituted or substituted by one or more hydroxyl, halogen, phenyl, cyano, and/or C₁-C₆-alkoxycarbonyl and/or sulfonic acid and has a total of from 1 to 20 carbon atoms, for example methyl, ethyl, 1-propyl, 2-propyl, 1-butyl, 2-butyl, 2-methyl-1-propyl(isobutyl), 2-methyl-2-propyl(tert-butyl), 1-pentyl, 2-pentyl, 3-pentyl, 2-methyl-1-butyl, 3-methyl-1-butyl, 2-methyl-2-butyl, 3-methyl-2-butyl, 2,2-di dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxy-carbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;
glycols, butylene glycols and oligomers thereof having from 1 to 100 units, with all the above groups bearing a hydrogen or a C₁-C₈-alkyl radical as end group, for example R^{A}O—(CHR^{B}—CH₂—O), —CHR^{B}—CH₂— or R^{A}O—(CH₂CH₂CH₂CH₂O), —CH₂CH₂CH₂CH₂O— where R^{A} and R^{B} may each be hydrogen, methyl or ethyl and n may be 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
vinyl; and
N,N-di-C₁-C₆-alkylamino, such as N,N-dimethylamino and N,N-diethylamino.

If two adjacent radicals together form an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups, they may form, for example, 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

In some embodiments, the radicals R, R¹ to R⁹ are included, each being, independently of one another, hydrogen or C₁-C₁₈-alkyl such as methyl, ethyl, 1-butyl, 1-pentyl, 1-hexyl, 1-heptyl, 1-octyl, phenyl, 2-hydroxyethyl, 2-cyanoethyl, 2-(methoxycarbonyl)ethyl, 2-(ethoxycarbonyl)ethyl, 2-(n-butoxycarbonyl)ethyl, N,N-dimethylamino, N,N-diethylamino or CH₃O—(CH₂CH₂O), —CH₂CH₂— and CH₃CH₂O—(CH₂CH₂O), —CH₂CH₂— where n is from 0 to 3.

In some cases, radicals R, R¹ to R⁹ are all different forming a less symmetrical (e.g., an asymmetrical) ion. Asymmetry may lead to the ionic liquid having a lower melting point and an extended temperature operational range (compared to a similar but symmetrical compound).

Compounds suitable for the formation of the cation [A]⁺ of ionic liquids are known, for example, from DE 102 02 838 A1. In some embodiments, such compounds can comprise oxygen, phosphorus, sulfur, or nitrogen atoms. A compound including nitrogen may comprise, for example, at least one nitrogen atom, from 1 to 10 nitrogen atoms, from 1 to 5 nitrogen atoms, from 1 to 3 nitrogen atoms, or 1 or 2 nitrogen atoms. If appropriate, further heteroatoms such as oxygen, sulfur or phosphorus atoms can also be included. The nitrogen atom may be a suitable carrier of the positive charge in the cation of the ionic liquid, from which a proton or an alkyl radical can then go over in equilibrium to the anion to produce an electrically neutral molecule.

If the nitrogen atom is the carrier of the positive charge in the cation of the ionic liquid, a cation can firstly be produced by quaternization of the nitrogen atom of, for instance, an amine or nitrogen heterocycle in the synthesis of the ionic liquid. Quaternization can be effected by alkylation of the nitrogen atom. Depending on the alkylation reagent used, salts having different anions are obtained. In cases in which it is not possible to form the desired anion in the quaternization itself, this can be brought about in a further step of the synthesis. Starting from, for example, an ammonium halide, the halide can be reacted with a Lewis acid, forming a complex anion from the halide and Lewis acid. As an alternative, replacement of a halide ion by the desired anion is possible. This can be achieved by addition of a metal salt with precipitation of the metal halide formed, by means of an ion exchanger or by displacement of the halide ion by a strong acid (with liberation of the hydrogen halide). Suitable methods are described, for example, in Angew. Chem. 2000, 112, pp. 3926-3945, and the references cited therein, which are incorporated herein by reference.

Suitable alkyl radicals by means of which the nitrogen atom in the amines or nitrogen heterocycles can, for example, be quaternized include C₁-C₁₈-alkyl, e.g., C₁-C₁₀-alkyl, C₁-C₆-alkyl, e.g., methyl. The alkyl group can be unsubstituted or have one or more identical or different substituents.

[Y]ⁿ⁻ may be selected from
the group of halides and halogen-comprising compounds of the formulae:
   F⁻, Cl⁻, Br⁻, I⁻, BF₄⁻, PF₆⁻, AICI₄⁻, AI₂CI₇⁻, AI₃CI₁₀⁻, AIBr₄⁻, FeCl₄⁻, BCl₄⁻, SbF₆⁻, AsF₆⁻, ZnCI₃⁻, SnCI₃⁻, CuCI₂⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae:
   SO₄²⁻, HSO₄⁻, SO₃²⁻, HSO₃⁻, R^{a}OSO₃⁻, R^{a}SO₃⁻
the group consisting of phosphates of general formulae:
   PO₄³⁻, HPO₄²⁻, H₂PO₄⁻, R^{a}PO₄²⁻, HR^{a}PO₄⁻, R^{a}R^{b}PO₄⁻
the group consisting of phosphonates and phosphinates of general formulae:
   R^{a}HPO₃⁻, R^{a}R^{b}PO₂⁻, R^{a}R^{b}PO₃⁻
the group consisting of phosphites of general formulae:
   PO₃³⁻, HPO₃²⁻, H₂PO₃⁻, R^{a}PO₃²⁻, R^{a}HPO₃⁻, R^{a}R^{b}PO₃⁻
the group consisting of phosphonites and phosphinites of general formulae:
   R^{a}R^{b}PO₂⁻, R^{a}HPO₂⁻, R^{a}R^{b}PO⁻, R^{a}HPO⁻
the group consisting of carboxylic acids of the general formulae:
   R^{a}COO⁻
the group of carbonates and carboxylic esters of the general formulae:
   HCO₃⁻, CO₃²⁻, R^{a}CO₃⁻
the group of borates of the general formulae:
   BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae:
   R^{a}BO₂²⁻, R^{a}R^{b}BO⁻
the group of silicates and esters of silicic acid of the general formulae:
   SiO₄⁴⁻, HSiO₄³⁻, H₂SiO₄²⁻, H₃SiO₄⁻, R^{a}R^{b}SiO₄³⁻, R^{a}R^{b}R^{c}SiO₄⁻, HR^{a}SiO₄²⁻, H₂R^{a}SiO₄⁻, HR^{a}R^{b}SiO₄⁻
the group consisting of salts of alkylsilane and arylsilane of the general formulae:
   R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group consisting of carboximides; bis(sulfonyl)imides and sulfonylimides of the general formulae:

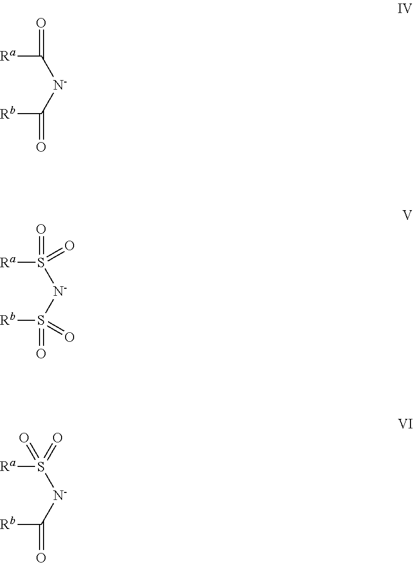

the group consisting of methide of the general formulae:

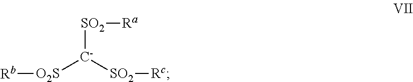

the group of alkoxides and aryloxides of the general formula: R^{a}O⁻;
   wherein radicals R^{a}, R^{b}, R^{c} and R^{d} independently from each other are selected from hydrogen; C₁-C₃₀-alkyl; C₂-C₁₈-alkyl which may optionally be interrupted by one or more nonadjacent oxygen and/or sulfur atoms and/or one or more substituted or un-substituted imino groups, C₆-C₁₄-aryl, C₅-C₁₂-cycloalkyl or a five- or six-membered, oxygen-, nitrogen- and/or sulfur-comprising heterocycle, and wherein two of R^{a}, R^{b}, R^{c} and R^{d} may together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

Radicals R^{a}, R^{b}, R^{c} and R^{d} may be selected from the radicals described for R, R¹ to R⁹.

In some embodiments, [A]⁺ is selected from the compounds of formulae IIIa, IIIc, IIIc, IIIe, IIIf; IIIg, IIIg′, IIIh, IIIi, IIIj, IIIj′, IIIk, IIIk′, IIIl, IIIm, IIIm′, IIIn, IIIn′, IIIu and/or IIIv. In some cases, [A]⁺ is selected from compounds of formulae IIIa, IIIe and/or IIIf.

In another embodiment, [A⁺] is an ammonium cation. The ammonium cation may be selected from quarternary ammonium compounds, e.g., from heterocyclic cationic compounds, wherein the N may be bound to two, three of four atoms. Examples for heterocyclic cationic compounds are pyridinium ions; pyridazinium ions; pyrimidinium; pyrazolium ions; imidazolium ions; pyrazolinium ions; imidazolium ions; pyrazolinium ions; imidazolinium ions; thiazolium ions; triazolium ions; pyrrolidinium ions; imidazolidinium ions; piperidinium ions; morpholinium ions; guanidinium ions and cholinium ions which may be substituted or unsubstituted.

In certain embodiments, [Y]ⁿ⁻ is selected from the group consisting of halides; halogen containing compounds; carboxylic acids; bis(sulfonyl)imides; NO₃⁻; SO₄²⁻, SO₃²⁻, R³OSO₃⁻; R^{a}SO₃⁻; PO₄³⁻ and R^{a}R^{b}PO₄⁻.

In one particular set of embodiments, ionic liquids are selected from the group consisting of ionic liquids being combinations of a monovalent cation selected from pyrrolidinium ions; imidazolidinium ions; piperidinium ions and guanidinium ions with a monovalent anion selected from bis(sulfonyl)imides; NO₃⁻, R^{a}OSO₃⁻ and R^{a}SO₃⁻, e.g., the ionic liquids are selected from compounds [A]⁺ [Y]⁻ wherein [Y]⁻ is selected from bis(sulfonyl)imides and [A]⁺ is selected from pyrrolidinium ions; [Y]⁻ is NO₃⁻ and [A]⁺ is selected from pyrrolidinium ions; [Y]⁻ is R^{a}OSO₃⁻ and [A]⁺ is selected from pyrrolidinium ions; [Y]⁻ is R^{a}R^{b}PO₄⁻ and [A]⁺ is selected from pyrrolidinium ions; [Y]⁻ is selected from bis(sulfonyl)imides and [A]⁺ is selected from imidazolidinium ions; [Y]⁻ is NO₃⁻ and [A]⁺ is selected from imidazolidinium ions; [Y]⁻ is R^{a}OSO₃⁻ and [A]⁺ is selected from imidazolidinium ions; [Y]⁻ is R^{a}R^{b}PO₄⁻ and [A]⁺ is selected from imidazolidinium ions; [Y]⁻ is selected from bis(sulfonyl)imides and [A]⁺ is selected from piperidinium ions; [Y]⁻ is NO₃⁻ and [A]⁺ is selected from piperidinium ions; [Y]⁻ is R^{a}OSO₃⁻ and [A]⁺ is selected from piperidinium ions; [Y]⁻ is R^{a}R^{b}PO₄⁻ and [A]⁺ is selected from piperidinium ions; [Y]⁻ is selected from bis(sulfonyl)imides and [A]⁺ is selected from guanidinium ions; [Y]⁻ is NO₃⁻ and [A]⁺ is selected from guanidinium ions; [Y]⁻ is R^{a}OSO₃⁻ and [A]⁺ is selected from guanidinium ions; [Y]⁻ is R^{a}R^{b}PO₄⁻ and [A]⁺ is selected from guanidinium ions. In some embodiments, if the pyrrolidinium ions; imidazolidinium ions; piperidinium ions and guanidinium ions are substituted, the substituents are all different, thereby forming a less symmetrical (e.g., an asymmetrical) ion. Asymmetry may lead to the ionic liquid having a lower melting point and an extended temperature operational range (compared to a similar, but symmetrical compound). In other embodiments, two or more, three or more, or four or more of the substituents are different from one another. In yet other embodiments, a symmetrical ion may be used.

In some embodiments, composition 30 optionally further comprises at least one lithium salt 38. Examples of suited lithium salts include LiPF₆, LiBF₄, LiB(C₆H₅)₄, LiSbF₆, LiAsF₆, LiClO₄, LiCF₃SO₃, LiC(SO₂CF₃)₃, Li(CF₃SO₂)₂N, LiC₄F₉SO₃, LiSbF₆, LiAlO₄, LiAICI₄, LiN(CₓF₂ₓ₊₁SO₂)(C_{y}F_{2y+1}SO₂) (wherein x and y are natural numbers), Libis(oxalato)borate (LiBOB), LiSCN, LiCl, LiBr, Lil, LiNO₃, LiNO₂ and mixtures thereof. In some cases, composition 30 contains at least one lithium salt 38 selected from the group consisting of LiPF₆, LiBF₄, LiNO₃, LiCF₃SO₃, LiC(SO₂CF₃)₃ LiN(CF₃SO₂)₂, LiC₄F₉SO₃, Lil, LiBr, LiSCN, LiBOB and mixtures thereof. If composition 30 contains one or more lithium salts, they may be present in an amount of, for example, at least 0.1 wt.-%, at least 0.2 wt.-%, at least 0.5 wt.-%, at least 1 wt.-%, or at least 1.5 wt.-%, and usually of at most to 50 wt.-%, at most 25 wt.-%, at most 15 wt.-% or at most 5 wt.-%, based on the total weight of composition 30.

In some embodiments, composition 30 comprises at least 0.5 wt.-% of the at least one polymer 36, at least 1 wt.-%, at least 1.5 wt.-%, or at least 3 wt.-% of the at least one polymer 36, based on the total weight of composition 30. In some cases, the composition 30 may comprise at least 10 wt.-% of the at least one polymer 36, at least 15 wt.-%, at least 20 wt.-%, at least 25 wt.-%, at least 30 wt.-%, at least 40 wt.-%, at least 50 wt.-%, at least 60 wt.-%, at least 70 wt.-%, or at least 80 wt.-% of the at least one polymer 36, based on the total weight of composition B. Usually the composition 30 contains not more than 95 wt.-%, not more than 90 wt.-%, or not more than 85 wt.-% of the at least one polymer 36, based on the total amount of composition B. In some cases, composition 30 contains not more than 70 wt.-%, not more than 60 wt.-%, not more than 50 wt.-%, not more than 40 wt.-%, or not more than 30 wt.-% of the at least one polymer 36, based on the total amount of composition B.

The content of the at least one ionic liquid 34 in composition 30 may be at least 1 wt.-%, at least 5 wt.-%, at least 10 wt.-%, at least 20 wt.-%, at least 30 wt.-%, or at least 50 wt.-% based on the total weight of composition 30.

In some embodiments, composition 30 may contain, for example:

1 to 50 wt.-% of at least one ionic liquid 34,
50 to 99 wt.-% of at least one polymer 36, and
0 to 30 wt.-% of at least one lithium salt 38,
based on the total weight of composition 30.

In certain embodiments, composition 30 contains, for example:

5 to 50 wt.-% of at least one ionic liquid 34,
49.5 to 94.5 wt.-% of at least one polymer 36, and
0.5 to 15 wt.-% of at least one lithium salt 38,
based on the total weight of composition 30.

In some embodiments, the Li ion conductivity of the composition may be at least 1×10⁻⁶ S/cm, at least 5×10⁻⁶ S/cm, at least 1×10⁻⁵ S/cm, at least 5×10⁻⁵ S/cm, at least 1×10⁻⁴ S/cm, or at least 5×10⁻⁴ S/cm. The Li ion conductivity may be in the range of, for example, between 1×10⁻⁶ S/cm to 1×10⁻³ S/cm, between 1×10⁻⁵ S/cm to 1×10⁻² S/cm, or between 1×10⁻⁴ S/cm to 1×10⁻² S/cm. Other values and ranges of Li ion conductivity are also possible.

In some embodiments, the Li-based anode may further comprise at least one protective layer which is located between the at least one anode active Li-containing compound and the at least one ionic liquid being admissible with the one or more electrolyte used in the electric current producing cell. The protective layer may be a single ion conducting layer, i.e. a polymeric, ceramic or metallic layer allowing Li⁺-ions to pass but which prevents or inhibits the passage of other components that may otherwise damage the electrode. Suited materials for the protective layer are known as such.

In some embodiments, suitable ceramic materials (H) may be selected from silica, alumina, or lithium containing glassy materials such as lithium phosphates, lithium aluminates, lithium silicates, lithium phosphorous oxynitrides, lithium tantalum oxide, lithium aluminosulf ides, lithium titanium oxides, lithium silcosulf ides, lithium germanosulfides, lithium aluminosulf ides, lithium borosulf ides, and lithium phosphosulf ides, and combinations of two or more of the preceding. Other materials may also be used. In some embodiments, a multi-layered protective structure may be used, such as those described in U.S. Pat. No. 7,771,870 filed Apr. 6, 2006 to Affinito et al., and U.S. Pat. No. 7,247,408 filed May 23, 2001 to Skotheim et al., each of which is incorporated herein by reference for all purposes.

Processes for preparing the Li-based anode described above are also provided. In some embodiments, a process comprises the steps
(i) providing at least one anode active Li-containing compound 20,
(ii) optionally applying a protective layer on the at least one anode active Li-containing compound 20, and
(iii) applying composition 30 on the at least one anode active Li-containing compound 20 or on the optionally present protective layer, respectively.

Composition 30 may be applied on the at least one anode active Li-containing compound or on the optionally present protective layer, respectively, by methods known by the person skilled in the art. Step (iii) may be performed in one step or may comprise two or more sub steps. Composition 30 may be applied in one step, e.g., as a solution or suspension of the at least one polymer 36 in the at least one ionic liquid 34. The solution or suspension may be applied via spraying, dipping, coating (e.g. with a doctor's blade) or rolling. The solution or suspension of the at least one polymer 36 in the at least one ionic liquid 34 may contain one or more solvents to facilitate the application of a film of homogenous thickness. The solvent(s) or a portion of the solvents may be removed afterwards.

It is also possible to carry out step (iii) by depositing a mixture of 34 and the respective monomer(s) and polymerizing said monomer(s) to form the at least one polymer 36. In this case the at least one polymer may be generated directly on the anode active Li-containing compound 20 or on the optionally present protective layer, respectively. The polymerization may be induced by radiation, e.g. UV-radiation, or heating. The mixture containing the monomer(s) may further contain additives required for performing the polymerisation like initiators etc.

In one particular embodiment, step (iii) comprises depositing a solution containing the at least one polymer 36 or depositing a mixture containing the respective monomer(s) and polymerizing said monomer(s) to form the at least one polymer 36.

It is also possible for step (iii) to comprise at least two sub steps. In the first sub step the at least one polymer 36 may be applied on the Li-containing compound 20 or the optionally present protective layer. This may be done by providing a mixture containing the at least one polymer 36 and/or the respective monomer(s) and one or more solvent, applying the mixture on the Li-containing compound 20 or the optionally present protective layer and polymerizing the monomers if present. The polymerization may be induced by radiation, e.g. UV-radiation, or heating. The mixture containing the monomer(s) may further contain additives required for performing the polymerisation like initiators etc. In a further sub step the solvent(s) or a portion of the solvent(s) may be removed, e.g., by evaporation, and the polymer layer may be immersed in the one or more ionic liquid or the solvent(s) may be exchanged by the one or more ionic liquid 34 whereby a gelled polymer layer is obtained. If one or more monomer(s) are used for applying the polymer layer on the Li-containing compound 20 or the optionally present protective layer, the one or more monomer(s) may serve as solvent, too and after polymerization residual monomers may be removed/exchanged by the at least one ionic liquid as described hereinbefore.

In some embodiments, one or more crosslinkable polymers and/or monomers forming crosslinkable polymers are used for providing the mixture which is applied on the at least one Li-containing compound/the optionally present protective layer for the preparation of composition 30. Said polymers and/or monomers may be crosslinked or polymerized and crosslinked, respectively, after application of the mixture on the at least one Li-containing compound or the optionally present protective layer to form a crosslinked polymer. The crosslinking may be induced by radiation, e.g. UV-radiation, or heating. The mixture containing the crosslinkable polymers/monomers may further contain additives required for performing the polymerisation like initiators or crosslinking agents. The crosslinked polymer forms a polymer gel together with the at least one ionic liquid. The at least one ionic liquid may be applied together with the polymer/monomer(s) or may be introduced later as described above via exchange of the solvent or immersing the polymer layer in the ionic liquid after removal of the solvent(s).

In one set of embodiments, an electric current producing cell is provided. The cell may comprise, for example:
(a) a cathode 40 comprising at least one cathode active material 44,
(b) a Li-based anode as described above, and
(c) at least one catholyte interposed between said cathode and said anode.

In some embodiments, the electric current producing cell comprises at least one catholyte interposed between the cathode and the anode. The catholyte(s) function as a medium for the storage and transport of ions. The catholyte(s) may be solid phase or liquid phase. Any suitable ionic conductive material can be used as long as the ionic conductive material is electrochemical stable.

The catholyte may comprise one or more materials selected from the group consisting of liquid electrolytes, gel polymer electrolytes, and solid polymer electrolytes. In some cases, the catholyte comprises
one or more electrolyte solvents 42A selected from the group consisting of N- and N,N-substituted acetamide like N-methyl acetamide and N,N-dimethyl acetamide; cyclic and acyclic acetals; acetonitrile; carbonates; sulfolanes; sulfones; N-substituted pyrrolidones; acyclic ethers; cyclic ethers; xylene; polyether including glymes; siloxanes and grafted polysiloxanes;
one or more ionic electrolyte salts 42B; and optionally
one or more polymers 42C selected from the group consisting of polyethers like polyethylene oxides, polypropylene oxides, polyacrylates, polyimides, polyphophazenes, polyacrylonitriles, polysiloxanes; grafted polysiloxanes, derivatives thereof, blends thereof, and copolymers thereof.

In one set of embodiments, the one or more ionic electrolyte salts 42B are selected from the group consisting of lithium salts including lithium cations, salts including organic cations, or a mixture thereof.

Non-limiting examples of lithium salts include LiPF₆, LiBF₄, LiB(C₆H₅)₄, LiSbF₆, LiAsF₆, LiClO₄, LiCF₃SO₃, Li(CF₃SO₂)₂N, LiC₄F₉SO₃, LiSbF₆, LiAlO₄, LiAICI₄, LiC(SO₂CF₃)₃, LiN(CₓF₂ₓ₊₁SO₂)(C_{y}F_{2y+1}SO₂) (wherein x and y are natural numbers), LiBOB, LiSCN, LiCl, LiBr, Lil, and mixtures thereof.

Examples of organic cation included salts are cationic heterocyclic compounds like pyridinium, pyridazinium, pyrimidinium, pyrazinium, imidazolium, pyrazolium, thiazolium, oxazolium, pyrrolidinium, and triazolium, or derivatives thereof. Examples of imidazolium compounds are 1-ethyl-3-methyl-imidazolium (EMI), 1,2-dimethyl-3-propylimidazolium (DMPI), and 1-butyl-3-methylimidazolium (BMI). The anion of the organic cation including salts may be bis(perfluoroethylsulfonyl)imide (N(C₂F₅SO₂)₂, bis(trifluoromethylsulfonyl)imide(NCF₃SO₂)₂⁻), tris(trifluoromethylsulfonylmethide(C(CF₃SO₂)₂, trifluoromethansulfonimide, trifluoromethylsulfonimide, trifluoromethylsulfonat, AsF₆⁻, ClO₄⁻, PF₆⁻, BF₄⁻, B(C₆H₅)₄⁻, sbF₆⁻, CF₃SO₃⁻, CF₃CH₃⁻, C₄F₉SO₃⁻, AlO₄⁻, AICI₄—, N(CₓF₂ₓ₊₁SO₂) (CyF_{2y+1}SO₂) (wherein x and y are natural numbers), SCN⁻, Cl⁻, Br⁻ and I⁻.

Furthermore, in some embodiments the electrolyte may contain ionic N—O electrolyte additives as described in WO 2005/069409 on page 10. In one particular set of embodiments, the electrolyte comprises LiNO₃, guanidine nitrate and/or pyridinium nitrate.

In some embodiments, the electrolyte salts 42B are selected from the group consisting of LiPF₆, LiBF₄, LiNO₃, LiCF₃SO₃, LiN(CF₃SO₂)₂ LiC₄F₉SO₃, Lil, LiC(SO₂CF₃)₃, LiBr, LiBOB, LiSCN and mixtures thereof.

In one set of embodiments, the one or more electrolyte solvents 42A are nonaqueous.

In one set of embodiments, the one or more electrolyte solvents 42A comprises a glyme. Glymes comprise diethylene glycol dimethylether (diglyme), triethylenglycol dimethyl ether (triglyme), tetraethylene glycol dimethylether (tetraglyme) and higher glymes. Polyethers comprise glymes, ethylene glycol divinyl ether, diethylene glycol divinyl ether, triethylene glycol divinyl ether, dipropylene glycol dimethyl ether, and butylenes glycol ethers.

In one set of embodiments, the one or more electrolyte solvents 42A comprises an acrylic ether. Acrylic ethers include dimethylether, dipropyl ether, dibutylether, dimethoxy methane, trimethoxymethane, dimethoxyethane, diethoxymethane, 1,2-dimethoxy propane, and 1,3-dimethoxy propane.

Cyclic ethers comprise tetrahydrofuran, tetrahydropyran, 2-methyltetrahydrofuran, 1,4-dioxane, trioxane, and dioxolanes.

The one or more electrolyte solvents 42A may be selected from the group consisting of dioxolanes and glymes. In some cases, the one or more solvent 42A is selected from diethylether, dimethoxyethane, dioxolane and mixtures thereof.

In one particular set of embodiments, the one or more catholyte comprise
one or more electrolyte solvents 42A selected from the group consisting of N-methyl acetamide, acetonitrile, carbonates, sulfolanes, sulfones, N-substituted pyrrolidones, acyclic ethers, cyclic ethers, xylene, polyether including glymes, and siloxanes; and
one or more ionic electrolyte salts 42B.

The cathode active material may be selected from the group consisting of sulphur (e.g., elemental sulphur), MnO₂, SOCl₂, SO₂Cl₂, SO₂, (CF)ₓ, I₂, Ag₂CrO₄, Ag₂V₄O₁₁, CuO, CuS, PbCuS, FeS, FeS₂, BiPb₂O₅, B₂O₃, V₂O₅, CoO₂, CuCI₂, transition metallithium oxides like LiCoO₂ and LiNiO₂, transition metal-lithium phosphates like LiFePO₄ and Li intercalating C.

In one embodiment, the cathode active material is sulphur. Since sulphur is non-conductive it is usually used together with at least one conductive agent. The conductive agent may be selected from the group consisting of carbon black, graphite, carbon fibres, graphene, expanded graphite, carbon nanotubes, activated carbon, carbon prepared by heat treating cork or pitch, a metal powder, metal flakes, a metal compound or a mixture thereof. The carbon black may include ketjen black, denka black, acetylene black, thermal black and channel black. The metal powder and the metal flakes may be selected from Sc, Ti, V, Cr, Mn, Fe, Co, Ni, Cu, Zn, Al, etc. Furthermore, the conductive agents may be electrically conductive polymers and electrically conductive metal chalcogenides.

The electric current producing cell may further comprise a separator between the anodic and the cathodic region of the cell. A separator may be used, for example, if the catholyte is a liquid phase. Typically, the separator is a porous non-conductive or insulative material which separates or insulates the anodic and the cathodic region from each other and which permits the transport of ions through the separator between the anodic and the cathodic region of the cell. The separator may be selected from porous glass, porous plastic, porous ceramic and porous polymer.

In a further embodiment the composition 30 is in direct contact with the solvent or mixture of solvents 42A contained in the catholyte (42) and the at least one polymer 36 is selected to be immiscible with the solvent or mixture of solvents 42A contained in catholyte (42). At their interface a solid layer of the at least one polymer 36 may optionally exist, formed by precipitation of the at least one polymer 36 in contact with the solvent or mixture of solvents 42A contained in the catholyte (42). This solid layer may act as separator and may improve the separation of the catholyte and the Li containing anode active compound.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A Li-based anode for use in an electric current producing cell, comprising:
at least one anode active Li-containing compound; and
a composition located between the at least one Li-containing compound and a catholyte used in the electric current producing cell, wherein the composition comprises:
at least one ionic liquid; and
at least one polymer compatible with the at least one ionic liquid.

2. The Li-based anode according to claim 1, further comprising at least one lithium salt.

3. The Li-based anode according to claim 1 wherein the catholyte used in the electric current producing cell comprises a solvent or mixture of solvents and the at least one polymer immiscible with said solvent or mixture of solvents.

4. The Li-based anode according to claim 1 wherein the at least one polymer is selected from the group consisting of cellulose, cellulose derivatives, polyacrylates, polyethers, polyethersulfones, copolymers comprising polyethersulfones, and mixtures thereof.

5. The Li-based anode according to claim 1 wherein the at least one polymer is selected from the group consisting of polyarylethersulfones, polysulfones, polyphenylsulfones, copolymers comprising polyarylethersulfones, polysulfones and/or polyphenylsulfones, and mixtures thereof.

6. The Li-based anode according to claim 1 wherein the at least one polymer is crosslinked.

7. The Li-based anode according to claim 1 wherein the at least one ionic liquid is selected from the group consisting of salts of the general formula (I)
[A]⁺ₙ[Y]ⁿ⁻ (I)
with n=1, 2, 3 or 4;
wherein
[A]⁺ is selected from the group consisting of ammonium cation, oxonoium cation, sulfonium cation, and phosphonium cation; and
[Y]ⁿ⁻ is a monovalent, bivalent, trivalent or tetravalent anion;
and of salts of the general formulae (IIa) to (IIc)
[A¹]⁺[A²]⁺[Y]ⁿ⁻(IIa) with n=2,
[A¹]⁺[A²]⁺[A³]⁺[Y]ⁿ⁻(IIb) with n=3, and
[A¹]⁺[A²]⁺[A³]⁺[A⁴]⁺[Y]ⁿ⁻(IIIc) with n=4,
wherein
[A¹]⁺, [A²]⁺, [A³]⁺ and [A⁴]⁺ independently from each other are selected from the group as defined for [A]⁺; and
[Y]ⁿ⁻ is defined as above.

8. The Li-based anode according to claim 7 wherein [A]⁺ is selected from compounds of formulae (IIIa) to (IIIy) 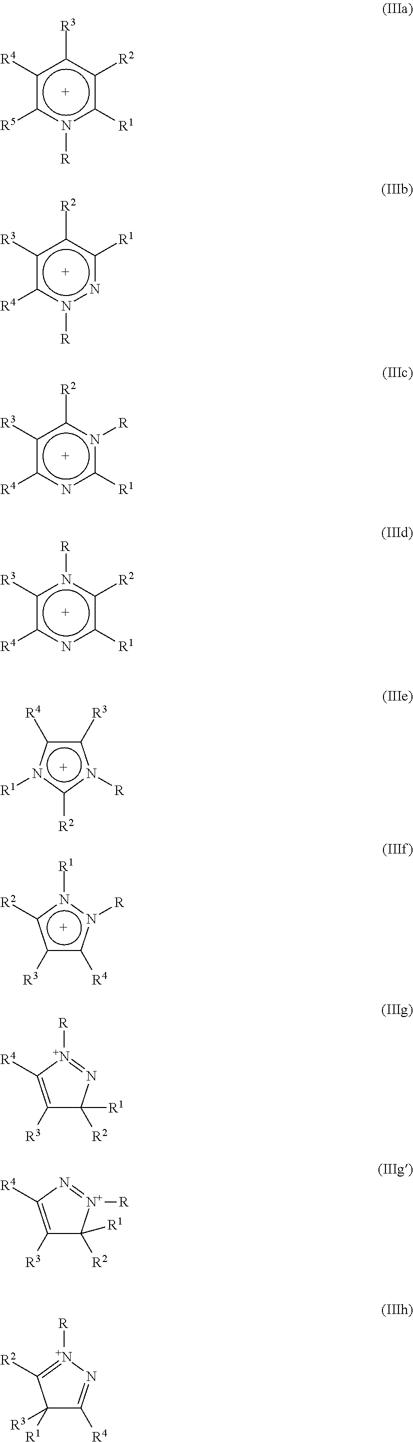 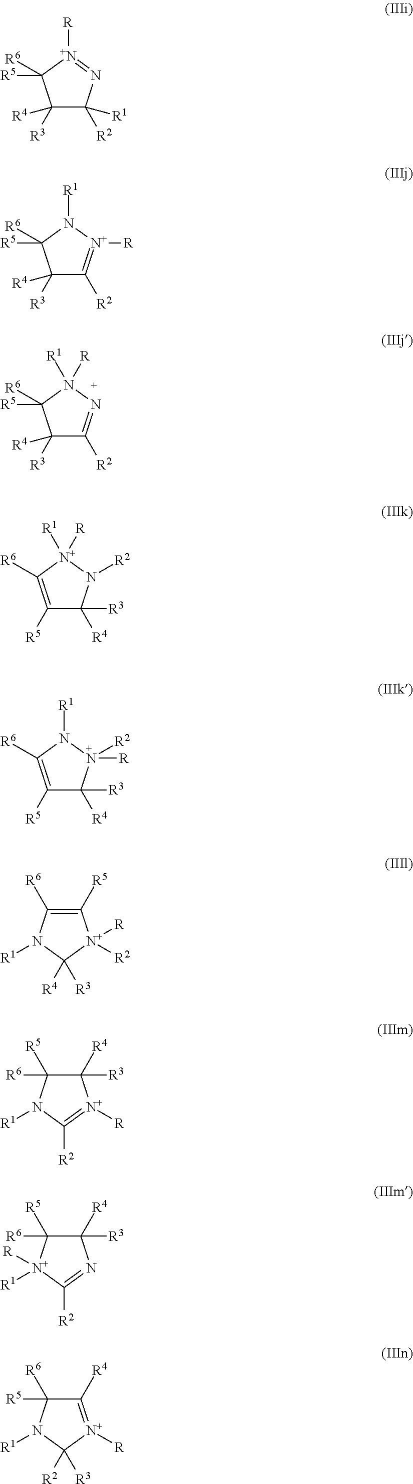 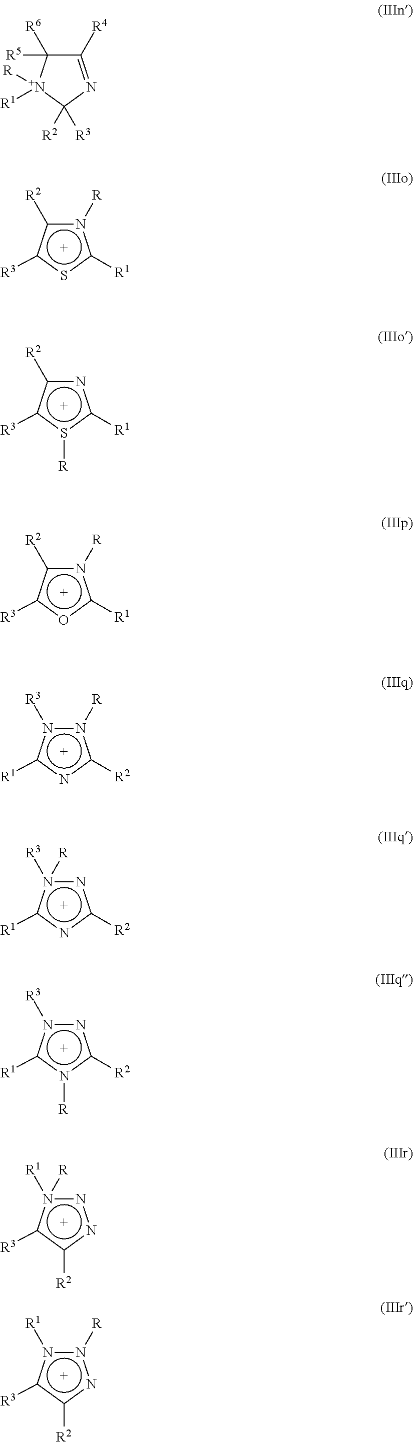 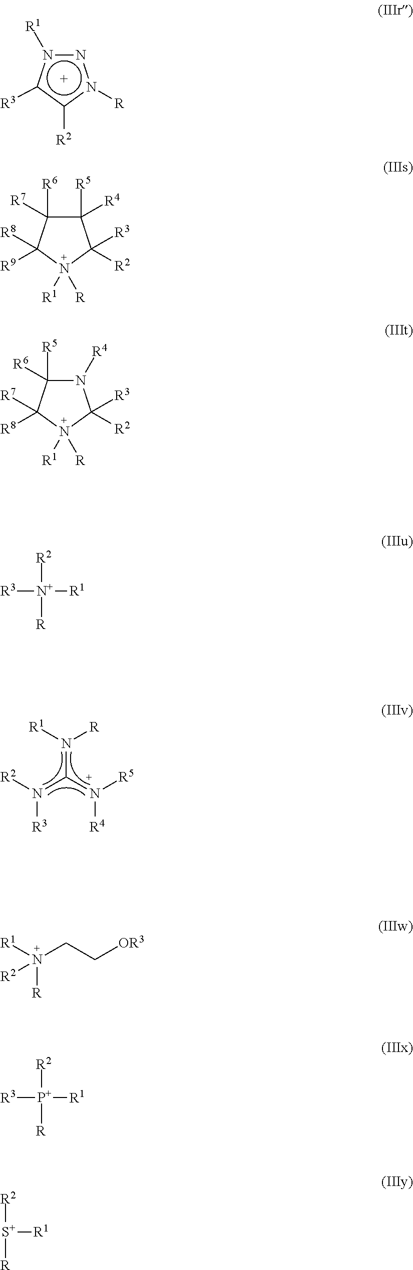
and oligomers comprising these structures; wherein
R is selected from hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
R¹ to R⁹ are independently from each other are selected from hydrogen; a sulfo-group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, wherein R¹ to R⁹ which are bound to a carbon atom in the formulae (IIIa) to (IIIy) may be selected from halogen or a functional group; and/or
two adjacent radicals from the group R¹ to R⁹ may be together a bivalent carbon containing organic saturated or unsaturated, acyclic or cyclic, aliphatic, aromatic or araliphatic radical which has from 1 to 30 carbon atoms and may be unsubstituted or interrupted or substituted by 1 to 5 hetero atoms or functional groups; and/or
two adjacent radicals from the group consisting of R and R¹ to R⁹ may together form a 3 to 7-membered saturated, unsaturated or aromatic ring and may be unsubstituted or be interrupted or substituted by from 1 to 5 heteroatoms or functional groups.

9. The Li-based anode according to claim 7 wherein [Y]ⁿ⁻ is selected from
the group of halides and halogen-comprising compounds of the formulae:
F, Cl⁻, Br⁻, I⁻, BF₄⁻, PF₆⁻, AICI₄⁻, AI₂Cl₇⁻, AI₃CI₁₀⁻, AIBr₄⁻, FeCl₄⁻, BCI₄⁻, SbF₆⁻, AsF₆⁻, ZnCI₃⁻, SnCI₃⁻, CuCI₂⁻, CF₃SO₃⁻, (CF₃SO₃)₂N⁻, CF₃CO₂, CCl₃CO₂⁻, CN⁻, SCN⁻, OCN⁻
the group of sulfates, sulfites and sulfonates of the general formulae:
SO₄²⁻, HSO₄⁻, SO₃²⁻, HSO₃⁻, R^{a}OSO₃⁻, R^{a}SO₃⁻
the group consisting of phosphates of general formulae:
PO₄³⁻, HPO₄²⁻, H₂PO₄⁻, R^{a}PO₄²⁻, HR^{a}PO₄⁻, R^{a}R^{b}PO₄⁻
the group consisting of phosphonates and phosphinates of general formulae:
R^{a}HPO₃⁻, R^{a}R^{b}PO₂⁻, R^{a}R^{b}PO₃⁻
the group consisting of phosphites of general formulae:
PO₃³⁻, HPO₃²⁻, H₂PO₃⁻, R^{a}PO₃²⁻, R^{a}HPO₃⁻, R^{a}R^{b}PO₃⁻
the group consisting of phosphonites and phosphinites of general formulae:
R^{a}R^{b}PO₂⁻, R^{a}HPO₂⁻, R^{a}R^{b}PO⁻, R^{a}HPO⁻
the group consisting of carboxylic acids of the general formulae:
R^{a}COO⁻
the group of carbonates and carboxylic esters of the general formulae:
HCO₃⁻, CO₃²⁻, R^{a}CO₃⁻
the group of borates of the general formulae:
BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B (R^{a}SO₄)⁻
the group of boronates of the general formulae:
R^{a}BO₂²⁻, R^{a}R^{b}BO⁻
the group of silicates and esters of silicic acid of the general formulae:
SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group consisting of salts of alkylsilane and arylsilane of the general formulae:
R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group consisting of carboximides; bis(sulfonyl)imides and sulfonylimides of the general formulae: 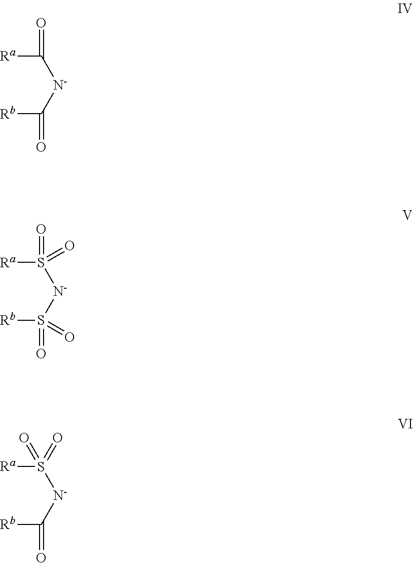
the group consisting of methide of the general formulae: 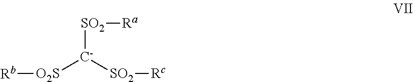
the group of alkoxides and aryloxides of the general formula:
R^{a}O⁻;
wherein R^{a}, R^{b}, R^{c} and R^{d} independently from each other are selected from hydrogen; C₁-C₃₀-alkyl; C₂-C₁₈-alkyl which may optionally be interrupted by one or more nonadjacent oxygen and/or sulfur atoms and/or one or more substituted or unsubstituted imino groups, C₆-C₁₄ aryl, C₅-C₁₂-cycloalkyl or a five- or six-membered, oxygen-, nitrogen- and/or sulfur-comprising heterocycle, and wherein two of R^{a}, R^{b}, R^{c} and R^{d} may together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

10. The Li-based anode according to claim 7 wherein [A]⁺ is selected from the compounds of formulae IIIa, IIIc, IIId, IIIe, IIIf; IIIg, IIIg′, IIIh, IIIi, IIIj, IIIj′, IIIk, IIIk′, IIIl, IIIm, IIIm′, IIIn, IIIn′, IIIu and/or IIIv.

11. The Li-based anode according to claim 7 wherein [A]⁺ is selected from compounds of formulae IIIa, IIIe and/or IIIf.

12. The Li-based anode according to claim 7 wherein [Y]ⁿ⁻ is selected from the group consisting of halides; halogen containing compounds; carboxylic acids; bis(sulfonyl)imides; NO₃⁻; SO₄²⁻, SO₃²⁻, R^{a}OSO₃⁻; R^{a}SO₃⁻; PO₄³⁻ and R^{a}R^{b}PO₄⁻.

13. The Li-based anode according to claim 2 wherein the at least one lithium salt is selected from the group consisting of LiPF₆, LiBF₄, LiNO₃, LiCF₃SO₃, LiN(CF₃SO₂)₂, LiC₄F₉SO₃, LiI, LiC(SO₂CF₃)₃, LiBr, LiBOB, LiSCN and mixtures thereof.

14. The Li-based anode according to claim 1 wherein the at least one anode active Li-containing compound is selected from the group consisting of Li-metal, Li-alloys and Li-intercalating materials.

15. The Li-based anode according to claim 1 wherein the Li-based anode further comprises at least one protective layer located between the at least one anode active Li-containing compound and the composition.

16. A process for preparing the Li-based anode according to claim 1 comprising the steps:
(i) providing at least one anode active Li-containing compound;
(ii) optionally applying a protective layer on the at least one anode active Li-containing compound; and
(iii) applying the composition on the at least one anode active Li-containing compound or on the optionally present protective layer, respectively.

17. The process according to claim 16 wherein in step (iii) the at least one polymer is cross-linkable and said polymer(s) is cross-linked after application on the at least one Li-containing compound or on the optionally present protective layer.

18. An electric current producing cell comprising:
(a) a cathode comprising at least one cathode active material;
(b) a Li-based anode according to claim 1; and
(c) at least one catholyte interposed between said cathode and said anode.

19. The electric current producing cell according to claim 18, wherein the catholyte comprises:
one or more electrolyte solvents selected from the group consisting of N-methyl acetamide, N,N-dimethyl acetamide, cyclic and acyclic acetals, acetonitrile, carbonates, sulfolanes, sulfones, N-substituted pyrrolidones, acyclic ethers, cyclic ethers, xylene, polyether including glymes, siloxanes and grafted polysiloxanes;
one or more ionic electrolyte salts; and
optionally one or more polymers selected from the group consisting of polyethers, polyimides, polyphophazenes, polyacrylonitriles, polysiloxanes; grafted polysiloxanes, derivatives thereof, blends thereof, and copolymers thereof.

20. The electric current producing cell according to claim 18 wherein the one or more solvent is selected from diethylether, dimethoxyethane, dioxolane or mixtures thereof.

21. The electric current producing cell according to claim 18 wherein the one or more ionic electrolyte salts are selected from the group consisting of LiPF₆, LiBF₄, LiNO₃, LiCF₃SO₃, LiN(CF₃SO₂)₂, LiC₄F₉SO₃, LiI, LiC(SO₂CF₃)₃, LiBr, LiBOB, LiSCN and mixtures thereof.

22. The electric current producing cell according to claim 18 wherein the cathode active material is selected from the group consisting of sulphur, MnO₂, SOCl₂, SO₂Cl₂, SO₂, (CF)ₓ, I₂, Ag₂Cra₄, Ag₂V₄O₁₁, CuO, CuS, PbCuS, FeS, FeS₂, BiPb₂O₅, B₂O₃, V₂O₅, CoO₂, CuCl₂, transition metal-lithium oxides, transition metal-lithium phosphates and Li intercalating C.

23. The electric current producing cell according to claim 18 wherein the cell further comprises a separator between the anode side and the cathode side.

24. The electric current producing cell according to claim 18 wherein the catholyte and the composition are in direct contact and the at least one polymer is selected as to be immiscible with the solvent or mixture of solvents contained in catholyte.

25. The electric current producing cell according to claim 18 wherein the ionic liquid has a melting point of less than 180° C.
